(19) United States
(12) Patent Application Publication
(10) Pub. No.: US 2025/0269782 A1
(43) Pub. Date: Aug. 28, 2025

(54) Watercraft Trailer and Latching Mechanism for Same and Related Method

(71) Applicant: Ramp N Clamp LLC, Lexington, KY (US)

(72) Inventor: Joseph C. Downs, Lexington, KY (US)

(21) Appl. No.: 19/055,272

(22) Filed: Feb. 17, 2025

Related U.S. Application Data
(60) Provisional application No. 63/556,670, filed on Feb. 22, 2024.

(51) Int. Cl. B60P 3/10; B62D 63/08

(52) U.S. Cl. CPC B60P 3/1066; B62D 63/08

(57) ABSTRACT

A watercraft trailer includes a latching mechanism for receiving a watercraft connection member in order to secure the watercraft on the trailer. The latching mechanism includes: (a) a support, having a channel adapted for receiving the watercraft connection member, (b) a latch member, including a receiver and a notch, (c) a pivot, connecting the latch member to the support, the latch member being displaceable about the pivot between a receiving position and a securing position, and (d) a plunger carried on the support, the plunger being displaceable between a home position and a retracted position. A distance D2 between the plunger in the home position and the pivot is greater than (b) a distance D1 between the receiver in the securing position at a centerline of the channel and the pivot.

### RELATED APPLICATIONS

This application claims benefit of U.S. Provisional Patent Application Ser. No. 63/556,670, filed Feb. 22, 2024, the disclosure of which is incorporated herein by reference in its entirety.

### FIELD OF THE INVENTION

The present invention relates generally to mechanisms for securing watercraft on a trailer; and more particularly to a latching mechanism supported by a watercraft trailer that receives a bow eye or the like typically affixed to the watercraft.

### BACKGROUND OF THE INVENTION

Trailers for transporting, launching and retrieving watercraft including fishing, skiing, or pleasure boats or jet skis are widely used by the public. While a variety of different winch and tow rope arrangements have been and may be employed to assist in securing the watercraft to the trailer, one commonly used element of such arrangements is a bow eye of some configuration which is affixed to the bow of the watercraft. Typically, the bow eye is positioned on the centerline of the watercraft which provides consistency from one type and/or size of watercraft to the next.

Over the years there have been attempts to minimize the reliance on ropes and winches during the loading and unloading of watercraft from trailers and to simplify the process using various latching members. In evaluating these trailer designs it is important to note that simplicity of operation is important but so too is the reliability of the latching mechanism. The applicant developed and patented one latching mechanism concept as described in U.S. Pat. No. 9,340,141 and incorporated herein by reference. The described latching mechanism utilizes a single cam or latching member to secure the bow eye and its watercraft in a semi-automatic manner. In the noted patent, the latching mechanism receives the bow eye and automatically secures the watercraft on the trailer. More specifically, the bow eye engages a latching member causing it to rotate and capture the bow eye in a secured position. A biased plunger attached to a handle is supported by the latching mechanism and extends linearly along a centerline of the latching mechanism and the watercraft. As the latching member rotates exposing a notch defined by the latching member to the plunger, the bias force extends the plunger into the notch which secures the latching member and the watercraft in the secured position. Operation of the handle withdraws the plunger from the notch allowing the latching member to counter rotate and return to its original and unsecured or receiving position. In this position, the bow eye of the watercraft is released and the watercraft may be removed from the trailer.

### SUMMARY OF THE INVENTION

The present invention meets these needs by providing a latching mechanism for use in association with a watercraft trailer for receiving a watercraft connection member (e.g., a bow eye, an U-shaped bolt, or the like) in order to secure the watercraft on the trailer. According to one aspect of the invention, the latching mechanism comprises, consists of or consists essentially of: (a) a support having a channel adapted for receiving the watercraft connection member, the channel having a centerline, (b) a latch member including a receiver and a notch, (c) a pivot connecting the latch member to the support, the latch member being displaceable about the pivot between a receiving position and a securing position, and (d) a plunger carried on the support, the plunger being displaceable between a home position and a retracted position. A distance D2 between the plunger in the home position and the pivot is greater than a distance D1 between the receiver, in the securing position at the centerline, and the pivot.

In at least one embodiment, the ratio of distance D2 to distance D1 is between 1.6 to 1 and 2.6 to 1. In at least one embodiment, the ratio of distance D2 to distance D1 is between 1.9 to 1 and 2.3 to 1. In at least one embodiment, the ratio of distance D2 to distance D1 is 2.1 to 1. In at least some of the many possible embodiments, the latching mechanism further includes a first spring biasing the latch member toward the receiving position and a second spring biasing the plunger toward the home position. In at least some embodiments, the latching mechanism further includes a guide track in the support. The plunger is received in and slides along the guide track. The plunger may engage an end of the guide track when in the home position.

In some embodiments, the latch member includes a cam adjacent the notch, wherein the cam is adapted to displace the plunger toward the retracted position as the latch member is displaced from the receiving position toward the securing position. In some embodiments, the plunger is biased into the notch when the latch member is in the securing position. In some embodiments, the latch member includes an arcuate leading edge bowing outward toward an entry opening of the channel.

In some embodiments, the guide track forms an included angle of between 10 degrees and 80 degrees with the centerline. In some embodiments, guide track forms an included angle of between 20 degrees and 70 degrees with the centerline. In some embodiments, the guide track forms an included angle of between 30 degrees and 60 degrees with the centerline. In some embodiments, the guide track forms an included angle of between 40 degrees and 50 degrees with the centerline. In some embodiments, latching mechanism further includes a cover of resilient material received over the support. Preferably, the cover has a flange that laps the support at the channel.

In accordance with an additional aspect, a latching mechanism for use with a watercraft having a watercraft connection member comprises, consists of or consists essentially of: (a) a support having a channel adapted for receiving the watercraft connection member and a guide track, (b) a latch member including a receiver and a notch, (c) a pivot connecting the latch member to the support, the latch member being displaceable about the pivot between a receiving position and a securing position, and (d) a plunger received in and adapted for sliding along the guide track, wherein the guide track forms an included angle of between 10 degrees and 80 degrees with a centerline of the channel.

In accordance with yet another aspect, a latching mechanism for use with a watercraft having a watercraft connection member comprises, consists of or consists essentially of: (a) a support having a channel adapted for receiving the watercraft connection member and (b) a cover of resilient material received over the support, the cover having a flange that laps the support at the channel.

In accordance with still another aspect, a trailer for use with a watercraft having a watercraft connection member comprises, consists of or consists essentially of a frame, at least two wheels and a latching mechanism. The frame is adapted to receive and support the watercraft. The wheels support the frame on the ground. The latching mechanism comprises, consists of or consists essentially of: (a) a support having a channel adapted for receiving the watercraft connection member, the channel having a centerline, (b) a latch member including a receiver and a notch, (c) a pivot connecting the latch member to the support, the latch member being displaceable about the pivot between a receiving position and a securing position, and (d) a plunger carried on the support, the plunger being displaceable between a home position and a retracted position. The distance D2, between the plunger in the home position and the pivot, is greater than a distance D1, between the receiver in the securing position at the centerline and the pivot.

Additional advantages and other novel features of the invention will be set forth in part in the description that follows and in part will become apparent to those skilled in the art upon examination of the following or may be learned with the practice of the invention. The objects and advantages of the invention may be realized and attained by means of the instrumentalities and combinations particularly pointed out in the appended claims.

### BRIEF DESCRIPTION OF THE DRAWING FIGURES

The accompanying drawings incorporated in and forming a part of the specification, illustrate several aspects of the present invention, and together with the description serve to explain the principles of the invention. In the drawings:

FIG. 1A and 1B are respective top plan and bottom plan views of the new latching mechanism with the latch member in the securing position.

FIG. 2A is a perspective view of the latching mechanism illustrated in FIG. 1, with the cover removed and the latching mechanism in the home or receiving position.

FIG. 2B is a top plan view of the latching mechanism illustrated in FIG. 1, with the cover removed and the latching mechanism in the home or receiving position.

FIG. 2C is a bottom plan view of the latching mechanism illustrated in FIG. 1, with the cover removed and the latching mechanism in the home or receiving position.

FIG. 2D is a right side elevational view of the latching mechanism illustrated in FIG. 1, with the cover removed and the latching mechanism in the home or receiving position.

FIG. 3A is a perspective view of the latching mechanism illustrated in FIG. 1 with (i) the second or lower section of the support and the cover removed and (ii) the latching member in the securing position.

FIG. 3B is a top plan view of the latching mechanism illustrated in FIG. 1 with the cover removed and the latching member in the securing position.

FIG. 3C is a bottom plan view of the latching mechanism illustrated in FIG. 1, with the second support section and the cover removed and the latching member in the securing position.

FIG. 3D is a right side elevational view of the latching mechanism illustrated in FIG. 1 with the cover removed and the latching member in the intermediate position.

FIGS. 4A and 4B are respective detailed perspective and bottom plan views of the first or upper section of the support of the latching mechanism.

FIGS. 5A and 5B are respective detailed perspective and bottom plan views of the second or lower section of the support of the latching mechanism. In FIG. 5B, the support bar is removed.

FIG. 6 is detailed bottom plan view of the latching member that is displaceable between receiving and securing positions.

FIGS. 7A-7D are a series of views illustrating how the latching member of FIG. 6 receives and capture a watercraft connection member. More specifically, FIG. 7A illustrates the latching member in the receiving position just as the watercraft connection member first touches the curved leading edge of the latching member. FIG. 7D illustrates the latching member in the securing position, capturing the watercraft connection member. FIGS. 7B and 7C illustrate the latching member in intermediate positions as the latching member rotates to fully receive and capture the watercraft connection member.

FIG. 8A is a detailed bottom plan view of the cover of the latching mechanism.

FIG. 8B is a detailed cross sectional view illustrating the flanges on the cover lapping over the first section of the support at the channel.

FIG. 9 illustrates the latching mechanism of FIG. 1 mounted to a boat trailer.

Reference will now be made in detail to the present preferred embodiment of the invention, an example of which is illustrated in the accompanying drawings.

### DETAILED DESCRIPTION OF THE PREFERRED EMBODIMENTS

In the following detailed description of the illustrated embodiments, reference is made to the accompanying drawings that form a part hereof, and in which is shown by way of illustration, specific embodiments in which the invention may be practiced. These embodiments are described in sufficient detail to enable those skilled in the art to practice the invention and like numerals represent like details in the various figures. Also, it is to be understood that other embodiments may be utilized and that process, mechanical, electrical, arrangement, software and/or other changes may be made without departing from the scope of the present invention. In accordance with the present invention, mechanisms and related methods are hereinafter described for use in association with a watercraft trailer for receiving a watercraft connection member in order to secure the watercraft on the trailer.

With reference to the Figures, there is shown an embodiment of a latching mechanism 10 for use in association with a watercraft trailer T for receiving a watercraft connection member B, or bow eye, in order to secure the watercraft (not shown) on the trailer. In accordance with the broad teaching of the invention, watercraft include boats, jet skis, and any other floating craft or submersible that relies on a trailer when being removed from water.

The latching mechanism 10 includes a cover 12 that partially conceals a support 14. In the illustrated embodiment, the support 14 comprises a first or upper section 14a and a second or lower section 14b held together by a plurality of fasteners 16. Spacers 18, received over the fasteners 16, maintain a working space, generally designated by reference number 20, between the two support sections 14a and 14b. The first section 14a defines a first channel (designated reference numeral 22) for receiving the watercraft connection member B. The support 14 of the latching mechanism 10 is preferably made of stainless steel in order to withstand the corrosive effects of water and provide sufficient strength to withstand being bumped or rammed by the watercraft during the loading and unloading processes. Of course, other metals and materials such as aluminum, titanium, and even carbon fiber can be used in accordance with the broad teaching of this document.

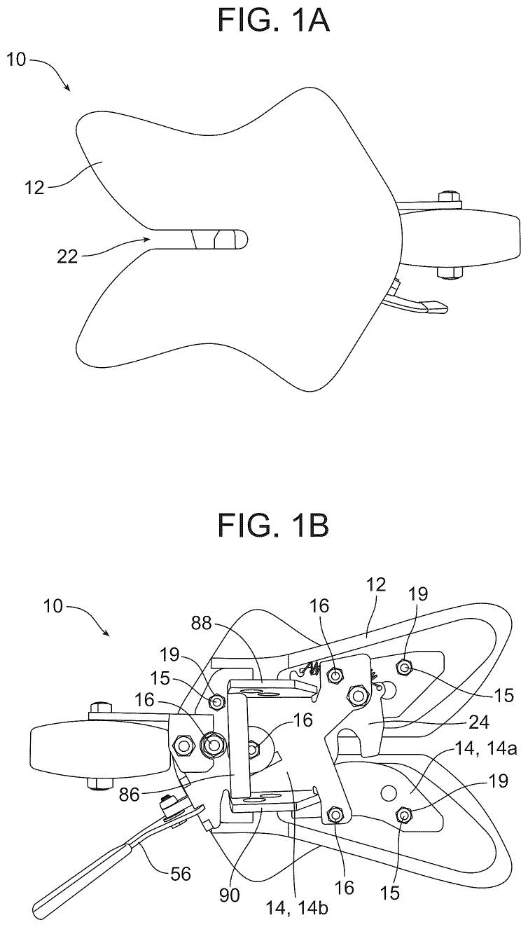

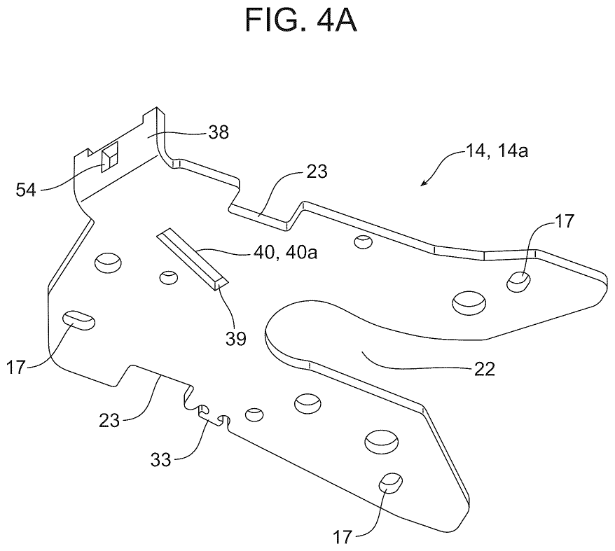

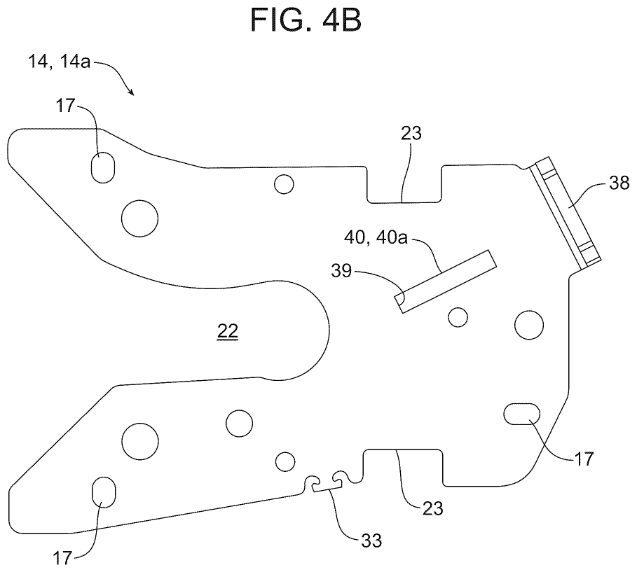

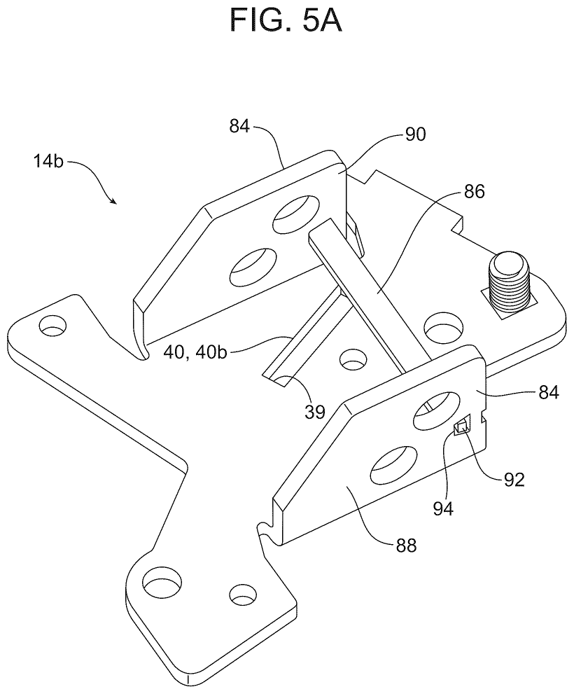

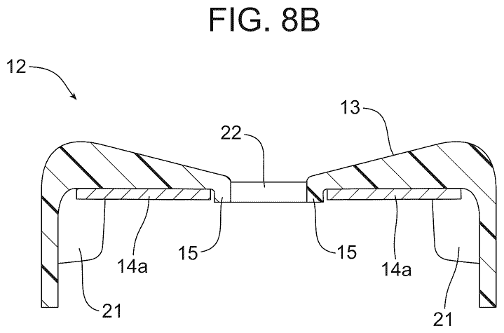

The cover 12 provides a contact surface 13 for engaging external elements such as a watercraft hull and protection against environmental elements. The material used for the cover 12 should be resilient enough to withstand repeated contact with the watercraft connection member B and watercraft hull during loading, unloading, and towing thereof. In the present embodiment, the cover 12 is made of urethane, which is non-marring and provides durability and flexibility, and is designed to essentially fit around the support 14 of the latching mechanism 10. Alternatively, polyvinyl chloride (PVC), rubber, polyethylene, and other plastics, thermoplastics, and moldable materials may be used to make the cover, and the cover could have a more standard shape so long as it is sufficient to cover the latching mechanism. Bolts 15 or the like can be used to secure the cover to the support 14. The bolts 15 may be molded into the cover 12 (see also FIG. 8A). When the cover 12 is secured to the support section 14a, the bolts extend through the apertures 17 in the support (see FIGS. 4a and 4b) and are secured in place by the nuts 19 (see FIG. 1b).

As shown in FIG. 8b, the cover 12 includes integral bolsters 21 at both sides. These bolsters 21 are aligned with the slots 23 in the support section 14a when the cover is positioned on the support section 14a. Downwardly depending flanges 15, on the cover 12, lap the support section 14a at the channel 22 to provide a damping effect upon contact with the watercraft connection member B when towing a trailer T.

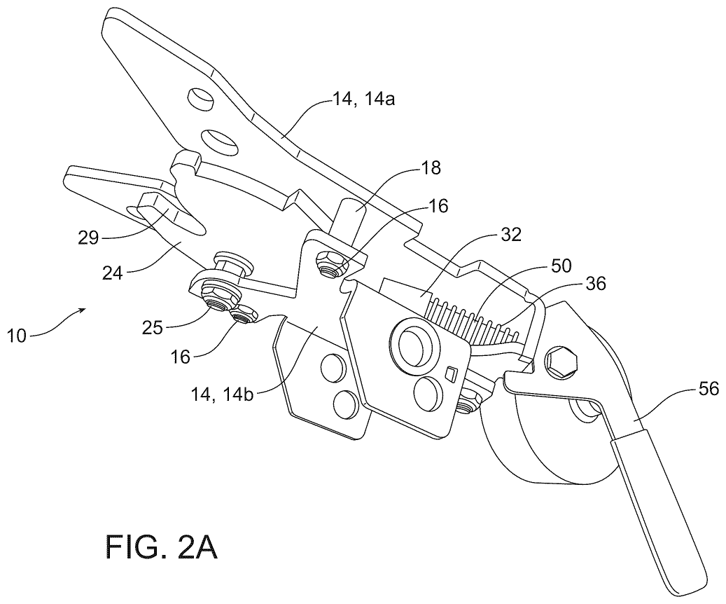

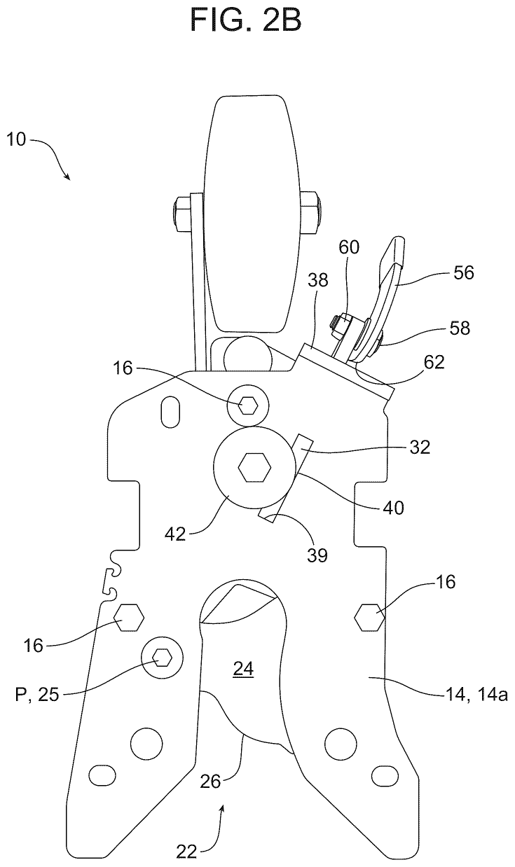

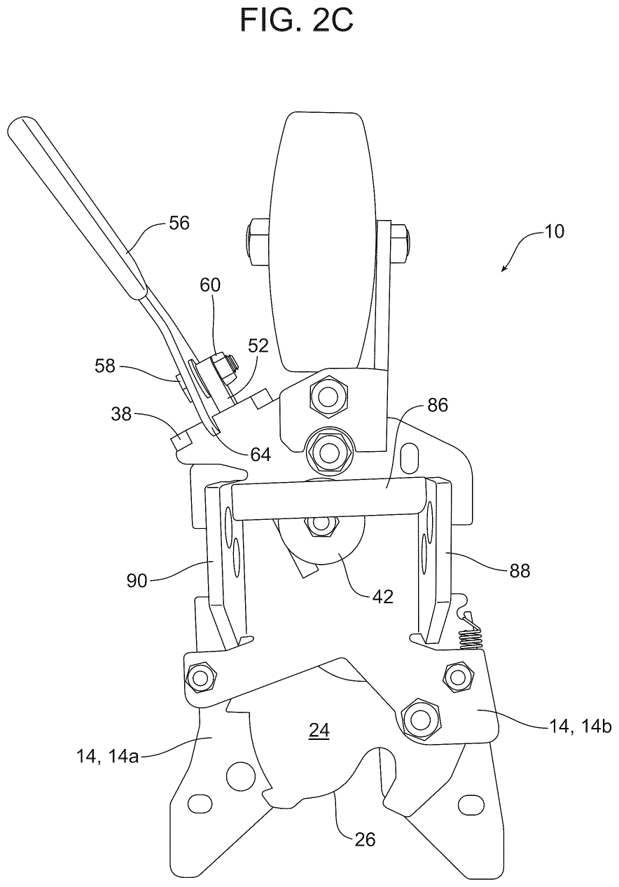

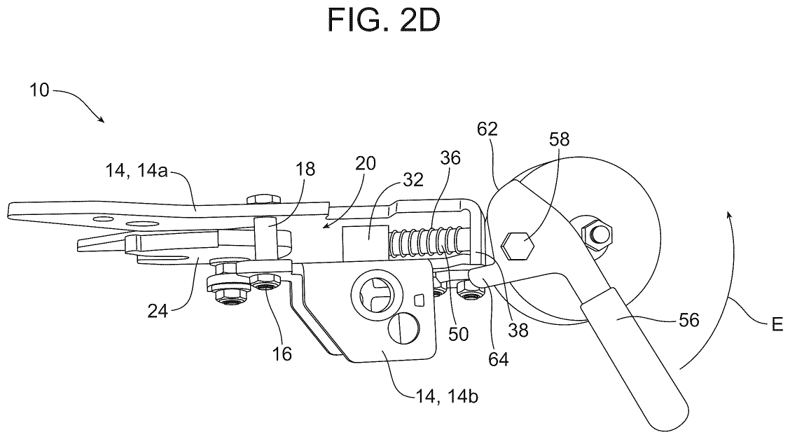

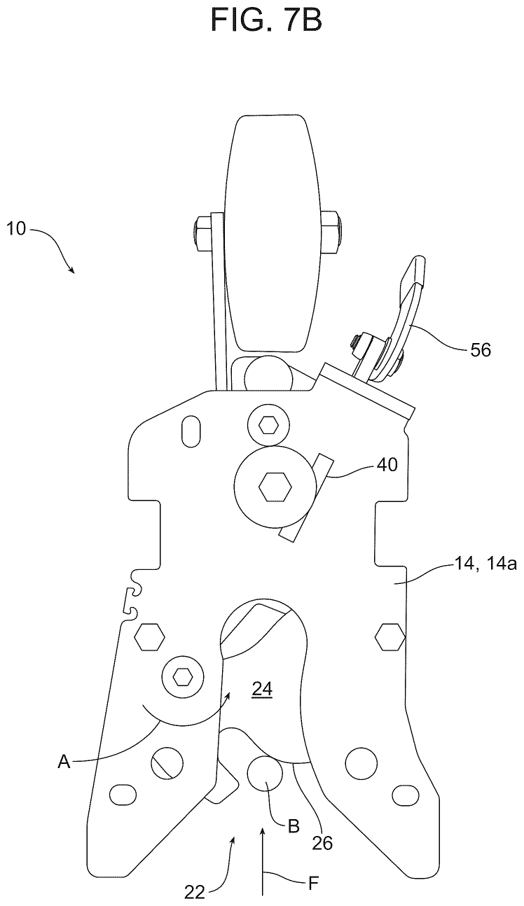

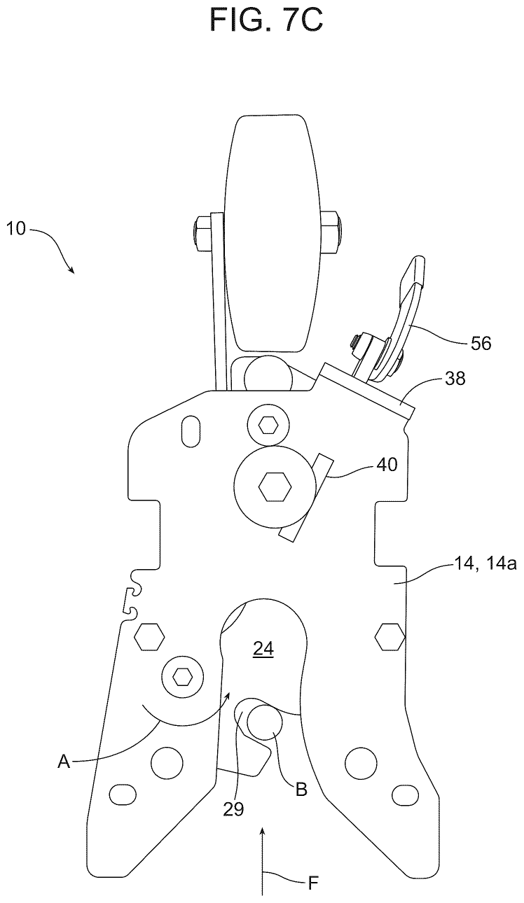

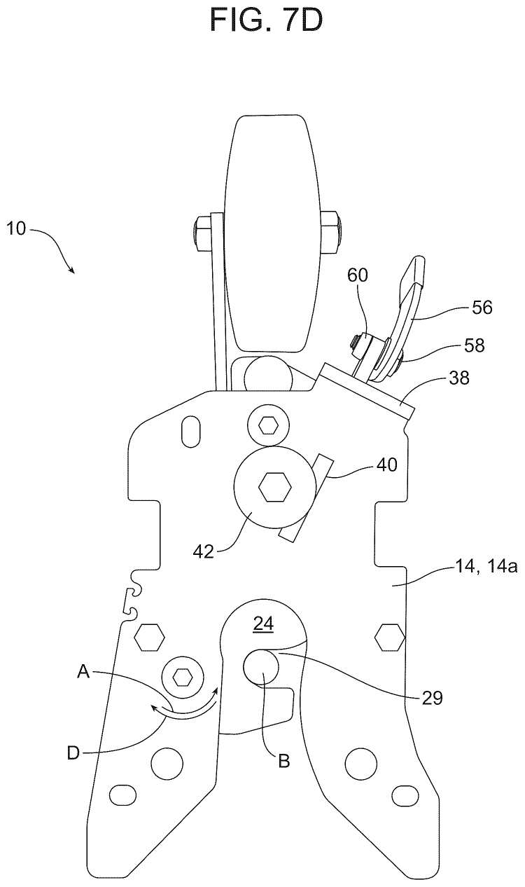

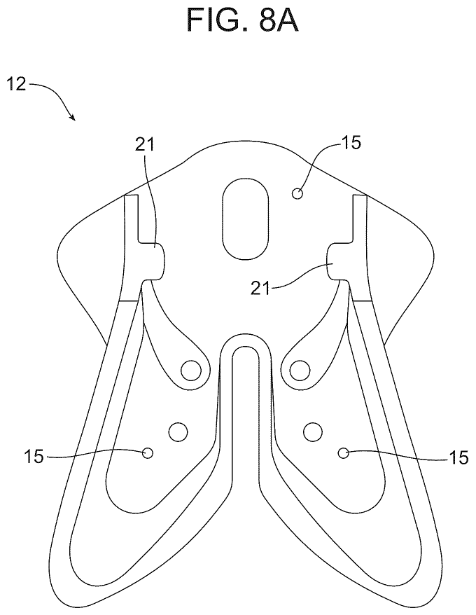

As shown in FIG. 2, a jaw or latching member 24 is supported by the support 14 for rotational movement about a pivot 25 between a receiving position and a securing position. More specifically, the latching member 24 is biased such that an arcuate leading edge thereof 26 is positioned to initially engage the watercraft connection member B in the receiving position during loading of the watercraft (See FIGS. 2A-2D and 7A). The latching member 24 may be biased using various types of springs, spring arrangements, or the like and, in the preferred embodiment, a first tension spring 28 connected between the latching member 24 (at aperture 27) and the support 14 (at catch 33) provides the noted bias. During loading of the watercraft, the watercraft connection member B is guided into support channel 22 by the support section 14a and contacts the leading edge 26 of the latching member 24. The force exerted on the leading edge 26 by the watercraft connection member B is sufficient to overcome the bias and rotate the latching member 24 in a counterclockwise direction about the pivot 25. The curvature of the leading edge 26 bows toward the open end or entry opening of the channel 22 so as to more quickly and efficiently rotate the latching member 24 toward a securing position and ultimate capture of the watercraft connection member B in the receiver 29 (Note FIGS. 7B and 7C illustrating rotation of the latching member in the direction of action arrow A toward the securing position illustrated in FIG. 7D).

As the watercraft connection member B moves farther into the first channel 22, a first cam surface 30 of the rotating latching member 24 contacts a plunger 32. The plunger 32 is biased toward the latching member 24. The plunger 32 may be biased using various types of springs, spring arrangements, or the like and, in the described embodiment, a compression spring 36 positioned between the plunger 32 and the support lug 38, depending from the first support section 14a, provides the noted bias.

When the first cam surface 30 contacts the head end 34 of the plunger 32, the plunger is in a resting or home position defined by engagement of the plunger against the end 39 of the guide track 40. As the latching member 24 continues to rotate in the direction of action arrow A, a force exerted on the plunger 32 by the first cam surface 30 becomes sufficient to overcome the spring bias and move the plunger toward the support lug 38. In the described embodiment, the plunger 32 at least partially extends into a guide track 40. Guide track 40 has a first section 40a in the first support section 14a and a second section 40b in the second support section 14b. Opposed margins of the plunger 32 engage in and slide along the guide track sections 40a and 40b to allow linear movement of the plunger head 32. Opposed fender washers 42 ensure that the plunger 32 remains centered in the guide track 40 for smooth operation. As the watercraft connection member B is displaced further into the channel 22, the force F applied to the latching member 24 (See FIGS. 7AB and 7C) is sufficient to overcome both the latching member bias and the plunger head bias.

At some point during rotation of the latching member 24 from the receiving position toward the securing position, the plunger 32 slides past the end 31 of the first cam surface 30. As this occurs, the biasing force provided by the compression spring 36 moves the plunger 32 into the notch 44 formed in the latching member 24. A first shoulder or stop 46, at a first end of the notch 44, is in position to engage the plunger 32 and limits further rotation of the latching member 24 in the direction of action arrow A, preventing further forward movement of the watercraft. In some instances, forward movement of the watercraft may be insufficient to rotate the latching member 24 far enough to engage the stop 46. Either way, rotation of the latching member 24 in the direction of action arrow A ceases and the latching member bias initiates rotation of the latching member in the direction of action arrow D (see FIG. 7D) toward its initial or receiving position. A second shoulder or stop 48, at a second end of the notch 44, is in position to engage the plunger 32 and limit further rotation of the latching member 24 in the direction of action arrow C, thereby maintaining the plunger 32 in the notch 44 and the latching member 24 in the securing position.

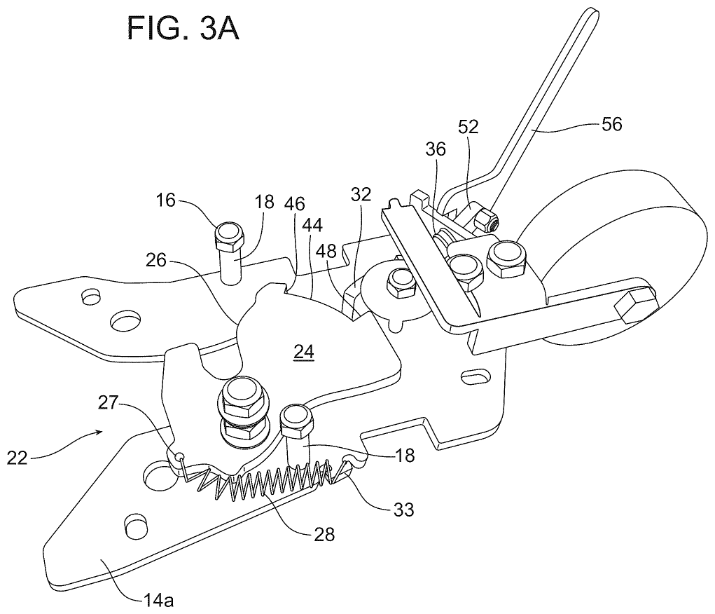

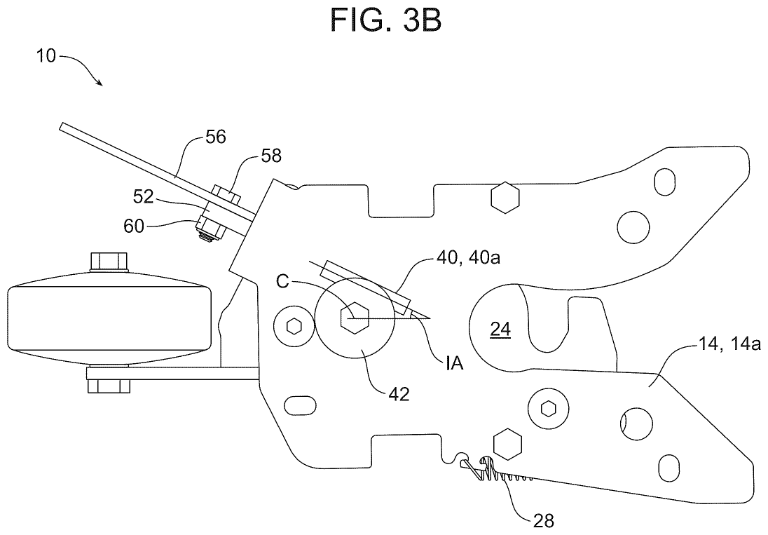

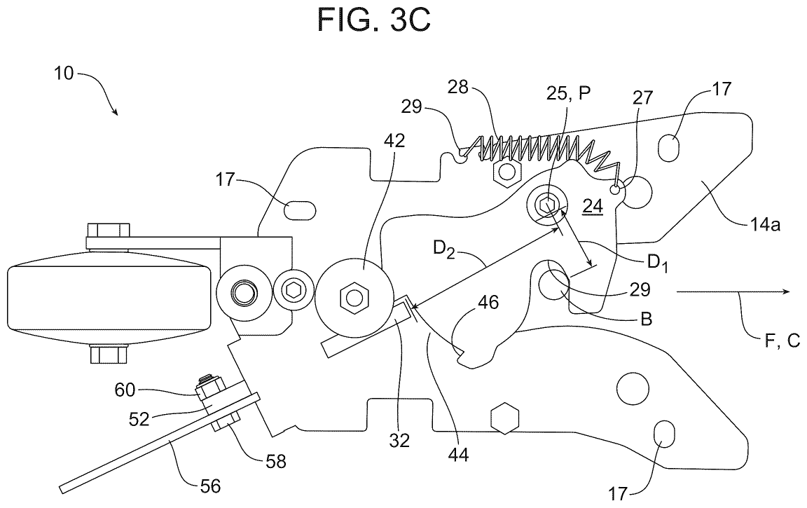

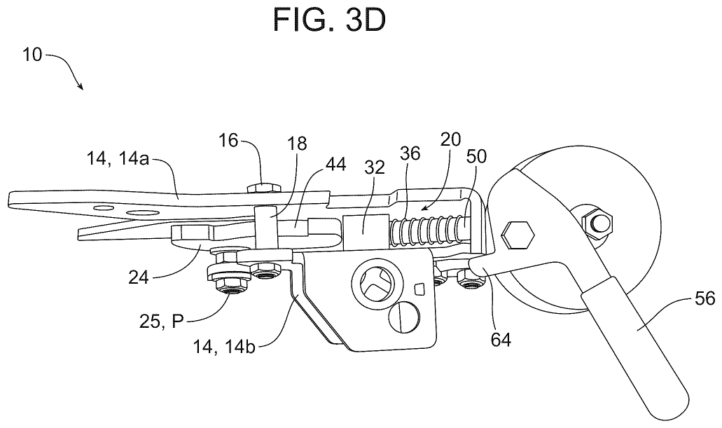

As best shown in FIG. 3C, the compression spring 36 is positioned over a central portion 50 of the plunger 32 such that the plunger extends within the second spring. A proximal end 52 of the plunger 32 is angled relative to the central portion 50 and extends through the guide window 54 in the support lug 38. In the illustrated embodiment, the angled, proximal end 52 is attached to a handle 56. More specifically, the handle 56 is rotationally connected to the plunger 32 using a bolt 58 and nut 60. The purpose of angling the proximal end 52 of the plunger is to reposition the handle 56 relative the watercraft in order to prevent contact with the watercraft which could cause damage thereto.

The handle 56 includes a cam surface 62. When the handle 56 is rotated in the direction of action arrow E (see FIG. 2D), the cam surface tends to pull the plunger 32 away from its home position at the end 39 of the guide track 40. Thus, the plunger 32 is moved from a locking position, wherein the plunger 32 engages in the notch 44 against the stop 46, to a release position wherein the plunger is disengaged from the notch. The disengagement of the plunger 32 from the notch 44 provides the necessary clearance to allow the shoulder or stop 46 to pass the plunger 32 as the biasing spring 28 rotates the latching member 24 back toward the home or receiving position. This, in turn releases the watercraft connection member B from the latching member 24. In order to prevent inadvertent release of the watercraft, a stub 64 extends from the handle 56 and contacts the support 14 in order to prevent clockwise rotation of the handle.

As noted above, the plunger 32 is retained in the guide track 40 formed in the support 14. The guide track 40 extends linearly and generally at an included angle IA relative a centerline C of the latching mechanism 10 and the watercraft (see FIG. 3B). Depending upon the embodiment, that included angle IA may be between (a) 10 degrees and 80 degrees, (b) 20 degrees and 70 degrees, (c) 30 degrees and 60 degrees, or (d) 40 degrees and 50 degrees. In the described embodiment, however, the offset or angling of the guide track 40, the plunger 32 and the handle 56 relative the centerline C provides improved access to the handle 56 and movement thereof without interference. In the watercraft industry, winches are traditionally attached to trailers adjacent to and linearly aligned with latching mechanisms and watercraft. Depending on the proximity of such a winch to a latching mechanism, placement of the winch could render an embodiment of the latching mechanism with a guide track extending parallel to the centerline C more difficult to operate. Offsetting or angling the guide track 40 in the manner described limits, if not eliminates, such potential interference issues.

The structural arrangement of the components in the new and improved latching mechanism 10 provide a number of benefits and advantages over prior art latching mechanisms such as shown in U.S. Pat. No. 9,340,141. First the distance D1, between the receiver 29, in the securing positon at the centerline C of the channel 22 (i.e. generally the first contact point where the connection member B contacts the latching member 24), and the pivot point P is greater than the distance D2 between the plunger 32, in the home position, and the pivot point P (i.e. generally the second contact point, where the notch side wall 44 contacts the plunger 32). Second the plunger 32 and handle 56 extend linearly and generally at an angle relative to the centerline C and the direction of the applied force F. This structural arrangement provides a longer lever arm for the handle operator at a beneficial operating angle, giving the mechanical and force advantage to the handle operator, thereby making it easier to rotate the handle 56 and release the latch member 24 to free the connection member B and the watercraft.

In contrast, in the prior art device disclosed in U.S. Pat. No. 9,340,141, the distance D1, between the receiver, in the securing positon at the centerline C of the channel (i.e. generally the first contact point where the connection member B contacts the latching member 24), and the pivot point P is less than the distance D2 between the plunger 32, in the home position, and the pivot point P (i.e. generally the second contact point, where the notch side wall 44 contacts the plunger 32). Further, the plunger and handle extend generally parallel to the centerline and the direction of the pulling force of the watercraft. This prior art structural arrangement provides a shorter lever arm for the handle operator versus the watercraft without any operating angle benefit, giving the mechanical and force advantage to the watercraft, thereby making it harder to rotate the handle 56 and release the latch member 24 to free the connection member B and the watercraft.

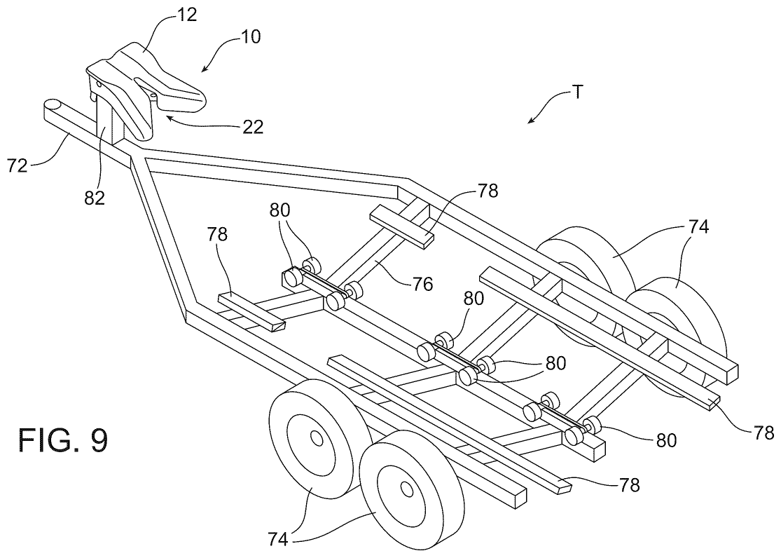

In one embodiment of the invention shown in FIG. 9, the latching mechanism 10 is mounted to a trailer T. The trailer T can be any type of watercraft trailer which are well known in the art, and may include a tongue 72 for towing purposes, a plurality of wheels 74, a frame 76, guides 78, and guide rollers 80 as desired. In the described embodiment, the latching mechanism 10 is mounted on a post 82 which in turn is mounted to the trailer T. In this embodiment, the post 82 is mounted on the tongue 72 of the trailer T. The latching mechanism 10 may be mounted to the trailer T in any manner so long as the channel 22 is positioned to receive the watercraft connection member B. Thus, positioning of the latching mechanism 10 depends on the type and size of watercraft and trailer T.

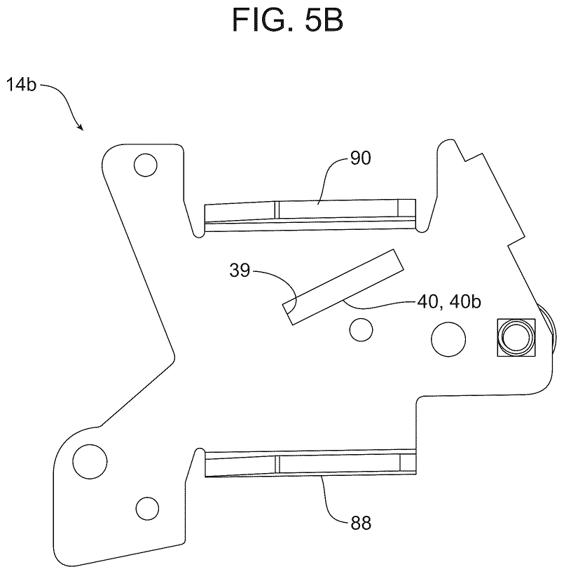

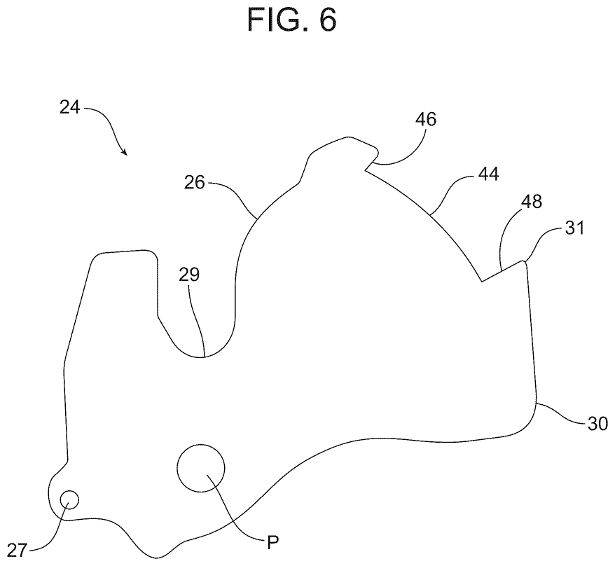

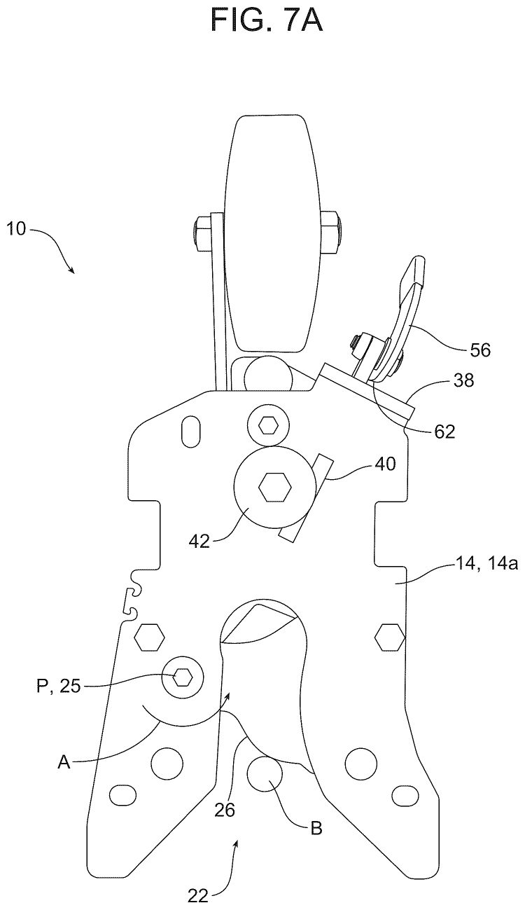

As best shown in FIGS. 5A and 5B, the support section 14b includes a mounting bracket 84. A support bar 86 extends between the two sides 88 and 90 of the mounting bracket 84. The support bar 86 is adapted to prevent deformation of the mounting bracket 84 due to overtightening when connected to the trailer 70. At least one tang 92 extends from an end of the support bar 86. The tang 92 is received in an aperture 94 defined by the mounting bracket side 88. In another embodiment, a first tang 92 is positioned within a first aperture 94 in side 88 and a second tang (not visible) is positioned with an aperture (not visible) in an opposing side 90.

When loading a watercraft W, the handle 56 of the latching mechanism 10 is positioned as shown in FIGS. 2A-2D. This allows the plunger 32 to be biased toward the home position. As illustrated in FIG. 7A, when the watercraft connection member B enters support channel 22 and contacts the leading edge 26 of the latching member 24, the force exerted on the edge 26 by the watercraft connection member B is sufficient to overcome the latching member bias and allow the latching member 24 to rotate in the direction of action arrow A. As the watercraft connection member B is forced further into the channel 22, the latching member 24 continues to rotate in the direction of action arrow A (see FIGS. 7B and 7C), capturing the watercraft connection member B. At the same time, the cam 30 on the latching member 24 engages the plunger 32, causing the plunger to retract from its home position toward the support lug 38. Once the cam 30 fully rotates past the plunger 32, the compression spring 36 biases the plunger into the notch 44 of the latching member 24. This secures the latching member 24 in the securing position, thereby capturing and holding the watercraft connection member B and ensuring that the watercraft W is secured on the trailer T (see FIG. 7D).

When the latching member 24 is held in the secured position and the watercraft W is secured on the trailer T, the handle 56 is in the position shown in FIG. 7D. To release the watercraft W from the trailer T, the handle 56 is rotated in the direction of action arrow D (see FIG. 2D) so that the cam surface 62 engages the support 14 thereby causing the plunger 32 to retract toward the support lug 38. Once the plunger 32 is retracted fully from the notch 44 in the latch member 24, the tension spring 22 biases the latch member back to the receiving position, freeing the watercraft connection member B and allowing the watercraft to float free of the trailer T.

The foregoing description of the preferred embodiment of the invention has been presented for purposes of illustration and description. It is not intended to be exhaustive or to limit the invention to the precise form disclosed. Obvious modifications or variations are possible in light of the above teachings. For example, different sizes and shapes of latching members and or bias methods can be used to accomplish the teaching of the present invention. Additional mounting holes or the like may also be provided and the dimensions and size of the channel 14 and support 12, and every other element of the mechanism can also vary as can the materials used in the construction thereof and the manner in which they are attached.

The embodiment was chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally and equitably entitled.

1. A latching mechanism for use with a watercraft having a watercraft connection member, comprising:
a support having a channel adapted for receiving the watercraft connection member, said channel having a centerline;
a latch member including a receiver and a notch;
a pivot connecting the latch member to the support, the latch member being displaceable about the pivot between a receiving position and a securing position; and
a plunger carried on the support, the plunger being displaceable between a home position and a retracted position;
wherein (a) a distance D2 between the plunger in the home position and the pivot is greater than (b) a distance D1 between the receiver in the securing position at the centerline and the pivot.

2. The latching mechanism of claim 1, wherein a ratio of distance D2 to distance D1 is between 1.6 to 1 and 2.6 to 1.

3. The latching mechanism of claim 1, wherein a ratio of distance D2 to distance D1 is between 1.9 to 1 and 2.3 to 1.

4. The latching mechanism of claim 1, wherein a ratio of distance D2 to distance D1 is 2.1 to 1.

5. The latching mechanism of claim 1, further including a first spring biasing the latch member toward the receiving position and a second spring biasing the plunger toward the home position.

6. The latching mechanism of claim 1, further including a guide track in the support and wherein the plunger is received in and slides along the guide track.

7. The latching mechanism of claim 6, wherein the plunger engages an end of the guide track when in the home position.

8. The latching mechanism of claim 7, wherein the latch member includes a cam adjacent the notch, wherein the cam is adapted to displace the plunger toward the retracted position as the latch member is displaced from the receiving position toward the securing position.

9. The latching mechanism of claim 8, wherein the plunger is biased into the notch when the latch member is in the securing position.

10. The latching mechanism of claim 1, wherein the latch member includes an arcuate leading edge bowing outward toward an entry opening of the channel.

11. The latching mechanism of claim 1, wherein the guide track forms an included angle of between 10 degrees and 80 degrees with the centerline.

12. The latching mechanism of claim 1, wherein the guide track forms an included angle of between 20 degrees and 70 degrees with the centerline.

13. The latching mechanism of claim 1, wherein the guide track forms an included angle of between 30 degrees and 60 degrees with the centerline.

14. The latching mechanism of claim 1, wherein the guide track forms an included angle of between 40 degrees and 50 degrees with the centerline.

15. The latching mechanism of claim 1, further including a cover of resilient material received over the support, the cover having a flange that laps the support at the channel.

16. A latching mechanism for use with a watercraft having a watercraft connection member, comprising:
a support having (a) a channel adapted for receiving the watercraft connection member, said channel having a centerline and (b) a guide track;
a latch member including a receiver and a notch;
a pivot connecting the latch member to the support, the latch member being displaceable about the pivot between a receiving position and a securing position; and
a plunger received in and adapted for sliding along the guide track, wherein the guide track forms an included angle of between 10 degrees and 80 degrees with the centerline.

17. A latching mechanism for use with a watercraft having a watercraft connection member, comprising:
a support having a channel adapted for receiving the watercraft connection member; and
a cover of resilient material received over the support. the cover having a flange that laps the support at the channel.
